(19) United States
(12) Patent Application Publication
(10) Pub. No.: US 2026/0249267 A1
(43) Pub. Date: Aug. 27, 2026

(54) Catalyst-Sorbent Hybrid Process for Organic Sulfur Removal

(71) Applicant: TDA Research, Inc., Golden, CO (US)

(72) Inventors: Gokhan Alptekin, Boulder, CO (US); Freya Kugler, Conifer, CO (US); Matthew Schaefer, Lakewood, CO (US)

(73) Assignee: TDA Research, Inc., Golden, CO (US)

(21) Appl. No.: 19/550,073

(22) Filed: Feb. 25, 2026

Related U.S. Application Data
(60) Provisional application No. 63/763,782, filed on Feb. 26, 2025.

(51) Int. Cl. B01J 20/20; B01D 53/04; B01D 53/86; B01J 20/28; C01B 32/50; C10L 3/10

(52) U.S. Cl. CPC B01J 20/20; B01D 53/0423; B01D 53/8668; B01J 20/2808; B01J 20/28083; C01B 32/50; C10L 3/103; B01D 2256/22; B01D 2257/306; B01D 2257/308; B01D 2258/05

(57) ABSTRACT

A hybrid process, comprising of a metal oxide catalyst and an advanced sorbent is for removing mercaptans, COS, CS₂ and other complex sulfide/disulfide compounds from natural gas, natural gas liquids, and CO₂ rich gas streams. A dedicated catalyst bed is used to dimerize the mercaptans into their respective disulfides. The removal of dimerized compounds is easily achieved over low-cost high surface area adsorbents. The catalyst has the desired surface functionalization to promote the reaction either in the presence of high concentrations of water or in dry gas streams. A low-cost mesoporous carbon adsorbent may be used to remove the heavy disulfide species with high capacity and removal efficiency. The pore size of the sorbent may be optimized to accommodate large species.

### RELATED APPLICATIONS

The present application claims the benefit of provisional application No. 63/763,782 filed Feb. 26, 2025, which is incorporated by reference herein.

### BACKGROUND

Mercaptans (thiols) are organic sulfur compounds, comprising SH groups attached to a hydrocarbon chain with a general formula of R—SH. They are toxic, highly reactive, and corrosive, volatile, organic compounds, commonly present in natural gas, landfill gas and off-gases generated in the petroleum refining, wood processing, and food industries. They are also found in the biogas generated in sewage/wastewater treatment facilities, dairy/hog farms, and agro-processing facilities.

Due to their health hazards, the mercaptan concentration in the air is restricted to levels according to the local environmental laws and living standards. COS (carbonyl sulfide) is a naturally occurring compound in natural gas, in off gases from chemical processing, natural gas and oil recovery, in combustion of coal, in biomass burning, etc., In high concentrations, COS can cause serious nervous system effects and acute respiratory failure. COS remains stable in air for many years eventually decomposing to sulfur oxides, which are known greenhouse gases. CS₂ (carbon disulfide) does not naturally occur; however, CS₂ often forms during the gas processing.

The removal of COS and CS₂ has been presented as a method to reduce the greenhouse effect. Both the sequestration processes and the utilization of carbon via catalytic or electrochemical processes require the deep purification of the captured CO₂. Utilization of CO₂ in food grade use requires its ultra purification, including the deep removal of sulfur compounds such as H₂S, COS, CS₂ and mercaptans, as well as the sulfur oxides, to less than 0.1 ppmv. The removal of COS and CS₂ from CO₂ presents a particular challenge as the heteroatoms S and O behave similarly in many adsorptive and catalytic purification systems.

While the conventional acid gas removal systems based on amine scrubbing and solid/liquid scavengers are used in removing hydrogen sulfide (H₂S) from natural gas and natural gas liquids, these technologies do not cost effectively remove the organic sulfur compounds such as mercaptans, carbonyl sulfide (COS), and carbon disulfide (CS₂).

### SUMMARY

A hybrid process, comprising a metal oxide catalyst and an advanced sorbent for removing mercaptans, COS, CS₂ and other complex sulfide/disulfide compounds from natural gas, natural gas liquids, and CO₂ rich gas streams. In the process, a dedicated catalyst bed may be used to dimerize the mercaptans into their respective disulfides. Due to the increased molecular weight and reduced volatility, the removal of dimerized compounds can be achieved over low-cost high surface area adsorbents. The catalyst may have the desired surface functionalization to promote the reaction either in the presence of high concentrations of water or in dry gas streams.

A low-cost mesoporous carbon adsorbent may be used to remove the heavy disulfide species with high capacity and removal efficiency. The pore size of the sorbent may be optimized to accommodate these large species. The sorbent capacity and cost justify the use of the new material in an expendable fashion in a simple and cost-effective process. The surface modification of the carbon sorbent may also provide the means to effectively remove COS and CS₂. Hence, the hybrid process may remove all organic sulfur compounds to ultra-low concentrations.

### BRIEF DESCRIPTION OF FIGURES

The support is described referring to the accompanying drawings, which show preferred embodiments according to the process described. The process as disclosed in the accompanying drawings is illustrated for example only. The elements and combination of elements described below and illustrated in the drawings can be arranged and organized differently to result in embodiments still within the spirit and scope of the process described.

These and other features, aspects, and advantages of the embodiments will become better understood regarding the following description, appended claims, and accompanying drawings.

FIG. 1 is a process diagram for hybrid mercaptan removal.

FIG. 2 is a chemical model of an interaction of the H₂S with carbon bound nitrogen groups.

FIG. 3 is a graphical representation of a pore size distribution of mesoporous carbon.

FIG. 4 is a chemical model of size estimates for various disulfide molecules.

FIG. 5 is a graphical representation of catalytic activity for conversion of methyl mercaptan and ethyl mercaptan into their respective homo- and hetero-dimers.

FIG. 6 is a graphical representation of experimental results for a mercaptan removal system.

FIG. 7 is a graphical representation of breakthrough profiles of mixed mercaptans.

FIG. 8 is a graphical representation of breakthrough profiles for methyl mercaptan, ethyl mercaptan, and total disulfide compounds.

FIG. 9 is a graphical representation of breakthrough profile for total sulfur, ethyl mercaptan, and total disulfide compounds for different temperatures.

FIG. 10 is a graphical representation of breakthrough profile for total sulfur, ethyl mercaptan, and total disulfide compounds for different catalyst: sorbent ratios.

FIG. 11 is a graphical representation of breakthrough profile for total sulfur, ethyl mercaptan, and total disulfide compounds for different moisture contents.

FIG. 12A is a graphical representation of a COS breakthrough profile.

FIG. 12B is a graphical representation of a chromatograph calibration test.

FIG. 13 is a graphical representation of COS breakthrough profiles over the new sorbent in ethylene and propylene gas.

FIG. 14 is a graphical representation of COS breakthrough profiles over the new sorbent in biogas.

FIG. 15A is a graphical representation of CS₂ breakthrough profile over the carbon sorbent in the presence of methanol.

FIG. 15B is a graphical representation of a sample gas chromatograph calibration test.

FIG. 16 is a graphical representation of CS₂ breakthrough profiles over the new sorbent in biogas.

In various figures, similar elements are provided with similar reference numbers. The drawing figures are not drawn to scale, or proportion, but instead are drawn to provide a better understanding of the components, and are not intended to be limiting in scope, but rather provide exemplary illustrations.

### DETAILED DESCRIPTION

A better understanding of different embodiments of the support may be gained from the following description read with the accompanying.

While the disclosure is susceptible to various modifications and alternative constructions, certain illustrative embodiments are in the drawings and will be described below. It should be understood, however, there is no intention to limit the disclosure to the embodiments disclosed, but on the contrary, the invention covers all modifications, alternative constructions, combinations, and equivalents falling within the spirit and scope of the disclosure and defined by the appended claims.

### Glossary

It will be understood that, unless a term is defined in this disclosure to possess a described meaning, there is no intent to limit the meaning of such term, either expressly or indirectly, beyond its plain or ordinary meaning.

“Dimerize” or “dimerization” refers to the process of combining two monomeric units to form a dimer.

“Lewis-acid” refers to a species that can accept an electron pair.

“Lewis-base” refers to a species that can donate an electron pair.

“Total sulfur” refers to the amount of mercaptan plus disulfide.

“PPMV” means parts per million on a volume basis.

“PPBV” means parts per billion on a volume basis.

“PPMW” means parts per million by weight.

Any element in a claim that does not explicitly state “means for” performing a specified function, or “step for” performing a function, is not to be interpreted as a “means” or “step” clause as specified in 35 U.S.C. § 112, paragraph 6.

### Invention

The concentration of mercaptans in sour natural gas needs to be reduced to protect the gas processing equipment and to meet pipeline sulfur specifications. In addition to the naturally occurring mercaptans, some complex mercaptans such as tertiary butyl mercaptan, isopropyl mercaptans, along with other complex sulfides such as dimethyl sulfide, are also added to the pipeline gas up to several ppmv concentrations as odorants for leak detection. Due to their boiling points, the low molecular weight mercaptans are commonly encountered in light hydrocarbon fractions. Low molecular weight mercaptans may include methyl mercaptan and ethyl mercaptan. They are primarily responsible for liquefied petroleum gas (“LPG”) feedstocks failing the copper strip tests. Other than H₂S, they are the most reactive sulfur compounds in LPG, and they readily react with and corrode the copper strip, even present in low concentrations.

Organic sulfur compounds, including the odorants added to the pipeline gas, are highly potent poisons to the catalysts and electro-catalysts used in the conversion of natural gas into chemicals and electricity. The organic sulfur compounds render the metal oxide and precious metal catalysts used in the chemical conversion processes inactive. The most common example is the Ni-based steam-methane-reforming catalyst and the Fe- and Cu-based water-gas-shift catalysts used in the conversion of methane into H₂; all three of these catalysts are highly susceptible to sulfur poisoning.

The sulfur compounds also poison the electro-catalysts used in fuel cells, which electrochemically convert the natural gas into electricity. Therefore, effective technologies are needed to remove these compounds to very low concentrations to protect the process equipment and the catalysts used in the chemical/electrochemical conversion processes that convert natural gas into value-added chemicals, transportation fuels, and power. Value-added chemicals may include H₂, and NH₃. COS and CS₂ can be removed via a number of processes, including but not limited to absorption, adsorption, reduction, photolysis, catalytic hydrolysis, and oxidation.

Among these methods, catalytic hydrolysis may be employed due to the mild reaction condition and high conversion rate, where the COS and CS₂ is hydrolyzed and subsequently removed with a metal oxide adsorbent. Following the H₂S removal from the gas, COS and CS₂ can be reacted with water to make H₂S and CO₂. The hydrolysis reactions commonly occur over alumina-based catalysts at 100-120° C. range to achieve the desired catalytic activity. It also requires addition of significant amounts of water to shift the equilibrium-limited hydrolysis reaction.

However, heating the natural gas and adding large amounts of water, especially if the gas is at high pressure, is not feasible. In these types of applications, molecular sieve adsorbents are used to remove COS and CS₂ via a regenerable process, which suffer from similar concerns reported for the regenerable mercaptan removal processes. Such processes may include oscillating flows and/or concentrations that can overload the SRU, and emissions concerns for applications that do not have an SRU. Some metal oxide scavengers, when sulfided, act as catalysts that convert H₂S into COS if the CO₂ content of the gas is high.

The caustic wash is another method of treating the light hydrocarbon streams as these streams are devoid of CO₂ that could react with and degrade the efficacy. However, the caustic wash cannot reduce the sulfur concentration to very low levels if light hydrocarbon fractions, such as ethylene or propylene, are to be used as a feedstock for chemical applications. There is an increasing demand for ultra purifying propane and butane fractions, such as nC₃, nC₄, and iC₄, as solvents to extract oils or fragrances from biomaterials. There is also a need to remove any sulfur odors from LPG fractions if they are to be used as propellants in consumer products such as deodorants, and shaving creams, as well as the propane torches used in commercial and residential kitchens.

There are increasing environmental concerns associated with the treatment of the resulting caustic residues in these processes. Gas streams that contain any appreciable amounts of CO₂ may also not be good candidates due to the reactivity of the caustic with CO₂. Caustic treatment may not be a viable option at all for treating CO₂ streams.

Iron sponge-iron oxide supported on wood chips—is an industrial adsorbent for removal of sulfur components from gas. However, the reactivity of the iron sponge with the mercaptans is very slow and cannot be used effectively in reducing the total sulfur concentration to very low levels in reasonably sized systems.

Zeolites and activated carbons may also be used. In a typical gas processing plant, the molecular sieve beds are installed downstream of the amine scrubbers to remove mercaptans and COS, however, due to their limited adsorption capacity, they are typically operated in regenerable configurations where the mercaptans are released as a concentrated off-gas stream by applying a thermal swing. The regenerable processes need to be combined with a secondary mercaptan consuming process, such as a conventional modified-Claus Sulfur Recovery Unit (“SRU”) to prevent the emission of these compounds, or their oxidized forms, into the atmosphere.

Even with plants equipped with an SRU (i.e., Claus unit), the handling of periodically regenerating beds with varying sulfur concentration is very difficult. Sending the sulfur-laden mol-sieve regeneration off-gas to the Claus unit not only increases the load to the Claus unit with mercaptans, CO₂, and heavy hydrocarbons, but also create operation problems as the concentrations of all these impurities in the regeneration gas vary during the regeneration cycle. This in turn causes rapid variations in the oxygen demand at the Claus reaction furnace. These fluctuations could be with the use of large buffer tanks at increased process cost and complexity.

Unlike the pipeline natural gas or light hydrocarbon fractions, the biogas generated by anaerobic digestion of biowaste, such as animal manure, vegetable clippings and wastewater, contains high levels of moisture. Biogas typically consist of 60-65% v/v CH₄ and 30% v/v CO₂, with some small amounts of N₂ and O₂ (2-3% v/v range). The gas is typically saturated at 40-50° C. with water. The sulfur concentration of the biogas needs to be reduced to meet the environmental emission requirements, if the biogas is burned to generate heat in a boiler or utilized in an internal combustion engine (“ICE”) that generates combined heat and power (“CHP”).

Biogas may be upgraded to biomethane, which is a renewable fuel, and bed injected into natural gas pipelines. Polymer membranes, and Pressure Swing Adsorption (“PSA”) systems, may be used to separate the CO₂ from methane. The treated gases have a very low-sulfur concentration requirement. In industry, the biomethane product must meet the pipeline sulfur requirement (<4 ppmv sulfur). The valorization of the recovered CO₂ as food grade CO₂ or in sequestration also imposes stringent purity requirements that often necessitates additional treatment of the CO₂ for sulfur and other impurities, such as volatile organic compounds.

Altogether, state-of-the-art sweetening technologies, for example amine or caustic scrubbing and regenerable adsorption, are capital intensive and unrealistic for large-scale applications. These systems also work well as bulk removal of sulfur compounds, but do not achieve deep removal. Mercaptans and organic sulfur compounds in the natural gas may not be adequately removed for all mercaptans and organic sulfur compounds. The <10 ppmw total S for NGLs is a challenging target for the state-of-the-art technologies, and off-gas treatment could be a problem.

To address these issues, a hybrid process may be comprised of an ambient temperature catalyst and a surface-modified activated carbon to remove organic sulfur compounds from natural gas and LPG. The catalyst may convert all the mercaptans into their respective disulfides, which may then be removed by a multi-functional mesoporous activated carbon sorbent.

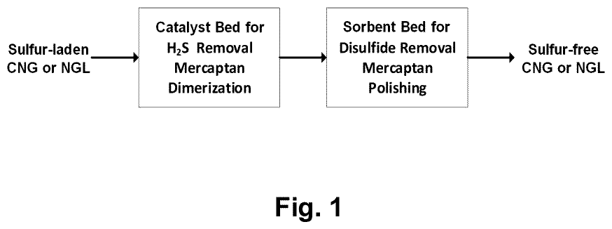

FIG. 1 shows a schematic of a hybrid mercaptan removal process. The surface modification, for example functional groups grafted onto the carbon surface, may also enable the removal of COS and CS₂. The hybrid process may be completely passive, meaning that it does not require addition of any chemicals, water, or oxygen.

The two-step hybrid process enables the removal of complex mercaptans using low-cost expendable media. It increases overall sulfur uptake by converting mercaptans into higher molecular weight disulfides, which have higher affinity to adsorb onto surfaces. In addition to the disulfides, the sorbent is highly effective in removing COS and CS₂. The catalyst may be a mixed-metal oxide grafted with reactive hydroxyl groups that can accept protons released by mercaptan-to-disulfide reaction.

The catalyst may consist of a high-surface-area mixed-metal-oxide phase that facilitates the dimerization of mercaptans. Some of the example dimerization reactions are shown for methyl mercaptan and ethyl mercaptan, where these compounds are oxidized to their respective homo dimers; dimethyl mercaptan and diethyl mercaptan, respectively. These mercaptan species could also react with each other and form heterodimers such as methyl ethyl disulfide:

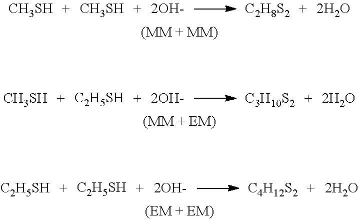

For adsorptive removal, the formation of dimers may be desirable as the formed dimers may have much higher adsorption potential using conventional, low-cost adsorbents such as activated carbons. Table 1 shows the molecular weight, vapor pressures and boiling points of select mercaptans and their potential homo- and hetero-dimers. Methyl Mercaptan (“MeSH”) is the lightest and most volatile compound of thiols. Because of these properties it may be the most difficult to remove via adsorption. However, its higher molecular weight dimers have a much higher affinity to condense over surfaces due to their lower vapor pressure and higher boiling points, for example methyl mercaptan has a vapor pressure of 1292 mmHg at 20° C. compared to 28.5 mmHg for dimethyl disulfide.

TABLE 1
The molecular weight, vapor pressures and boiling points of select
mercaptans and their potential homo- and hetero-dimers.

| | | | | Vapor |
|---|---|---|---|---|
| | | Molecular | Boiling | Pressure |
| | Chemical | Weight | Point | @20° C. |
| | Formula | g mol⁻¹ | ° C. | mmHg |
| Methyl mercaptan | CH₄S | 48.1 | 5.9 | 1292 |
| Ethyl mercaptan | C₂H₆S | 62.1 | 35 | 442 |
| n-Propyl mercaptan | C₃H₈S | 76.2 | 67 | 155 |
| Dimethyl disulfide | C₂H₆S₂ | 94.2 | 110 | 28.5 |
| Methyl ethyl disulfide | C₃H₈S₂ | 108.2 | 137 | 17.9 |
| Diethyl disulfide | C₄H₁₀S₂ | 122.3 | 151 | 4.3 |

Low-cost adsorbents, such as activated carbons, could then be used to remove the disulfide species with high capacity. However, these universal adsorbents need to have pore sizes that enable the access of these large molecules into the pores. Adsorption is a surface phenomenon and for high uptake of adsorbates, the adsorbent should have a high surface area. Most common activated carbon sorbents have micropores, and over 70-80% of the surface area of the activated carbon sorbents is in small size pores.

The adsorbent may accommodate larger molecules, such as by having a favorable pore size to allow their access. Large pore adsorbents may be used to effectively remove large disulfide molecules. The sorbent may be a mesoporous carbon grafted with Lewis-base functional groups, such as nitrogen containing amines.

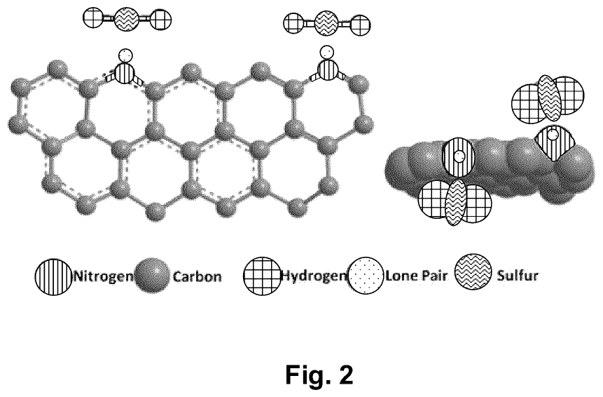

The sorbent may be a mesoporous carbon grafted with Lewis-base functionalized groups that remove sulfur compounds via strong physical adsorption, shown in FIG. 2. The carbon structure may be substituted with nitrogen groups that provide amine-like functionalities. X-ray Photoelectron Spectroscopy (“XPS”) results show that the nitrogen dispersed throughout the structure may be bonded to the carbon as a cyclic amine and not as an oxidized species, such as nitrites, nitrates. Because the nitrogen is not fully oxidized, it has a lone pair of electrons that attract sulfur compounds, which are Lewis-acids.

The nitrogen groups may be introduced to the carbon structure prior to a carburization step at 900° C. This may be before the carbon is activated. As a result, the active groups within the carbon structure may be tightly bound to the carbon, without risk of washing off or degassing. These nitrogen groups may also attract CO₂, which may be a weak Lewis acid; however, as the sulfur compounds are more acidic and due to their much higher affinity to the surface-active groups, they can replace adsorbed CO₂.

The carbon synthesis process may also include the use of various pore formers where the decomposition and off-gassing of these compounds generate the desired porosity. The pore size can be controlled by the selection of the size of the pore formers. As they leave the structure during the carburization step, meso-scale pores may be formed.

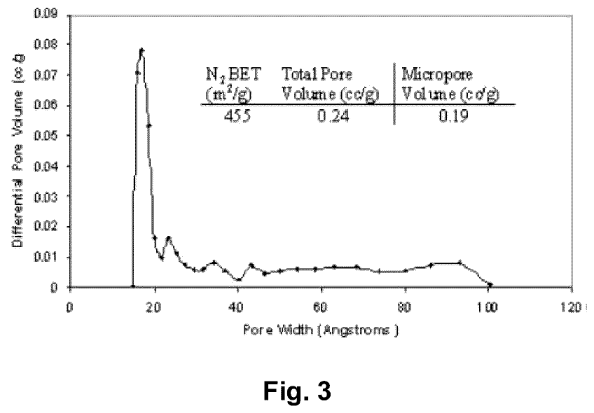

FIG. 3 shows the pore size distribution over one of the mesoporous carbons prepared by the described method. The pores may be, at least 10 Å, at least 12 Å, at least 15 Å, 10-30 Å, 10-25 Å, 10-20 Å, 12-30 Å, 12-25 Å, 12-20 Å, 15-30 Å, 15-25 Å, or 15-20 Å. This pore size may not only enable easy access of the large mercaptan and disulfide molecules, but also may achieve a high surface area, which is the key for a very high sulfur adsorption capacity.

The surface area of the new carbon sorbent may be in the range of 400-800 m²/g, which may allow nearly all the pores in the new carbon material to be accessible and the provided surface area to be well utilized.

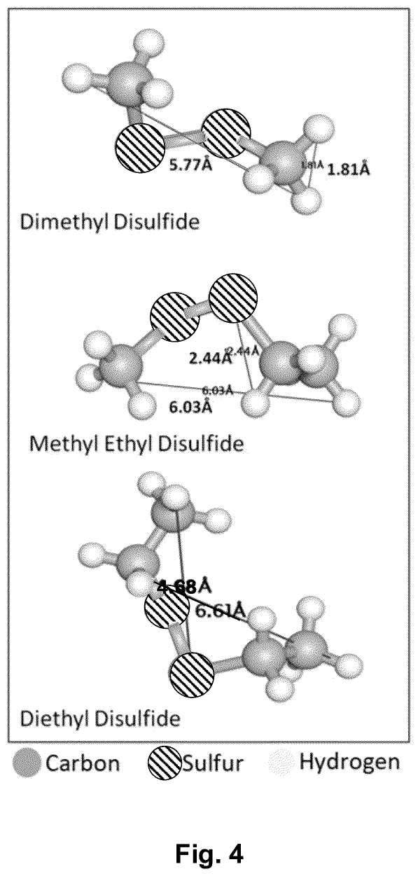

FIG. 4 shows molecular dimensions of various mercaptans and disulfide species. For example, the diethyl disulfide molecule 6.7 Å long and has a kinetic diameter close to 4.7 Å. This relatively large molecule will be able to enter through the about 15 Å size pore openings of the mesoporous carbon sorbent and will adsorb over the surface N-groups. Due to the small pore mouth openings of commercial microporous sorbents, these large molecules may not be able to enter the pores of the microporous carbons, resulting in low sulfur adsorption capacity.

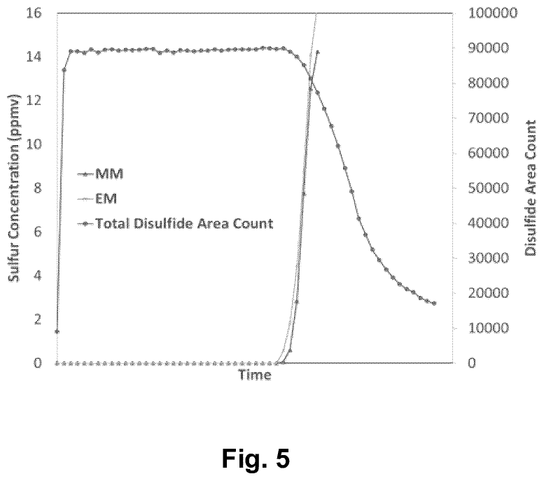

The performance of the catalyst may be demonstrated in a stand-alone test where the catalyst was used without the sorbent. FIG. 5 shows the activity of the catalyst for the conversion of methyl mercaptan and ethyl mercaptan into their respective homo- and hetero-dimers. Such dimers may include dimethyl disulfide, methyl ethyl sulfide, and/or diethyl disulfide.

In an example, 75 ppmv of methyl mercaptan and 75 ppmv of ethyl mercaptan were dimerized over the new catalyst at 40° C. in the presence of 1% vol. H₂O at a gas hourly space velocity (“GHSV”) of 15,000 h⁻¹. As shown in the figure, at the beginning of the test the mercaptans were dimerized into the disulfides. During this time, following a small lag, the total disulfide content of the gas steadily increased. While no mercaptans were observed, the disulfide concentration was above the detection level of the analyzer that it saturated the detector. As the surface-OH sites were expended due to the reaction with the H atoms from the mercaptans forming water, the dimerization process slowed down, and the disulfide concentration reduced to zero. This decline in the dimerization was followed by an increase in the methyl mercaptan and ethyl mercaptan concentration.

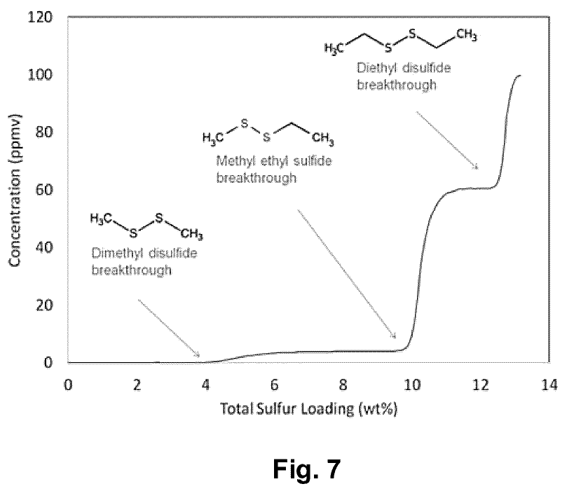

Sorbent efficacy for removing the dimerization products may be demonstrated in tests using the catalyst-sorbent combination. FIG. 7 shows the breakthrough profiles for mixed mercaptans eluting from the catalyst/sorbent bed. In an example, three different breakthrough events were evident, which belong to the different homo- and hetero-dimers of the methyl mercaptan and ethyl mercaptan. The initial breakthrough was observed for dimethyl disulfide at about 4.5% wt. S capacity. In agreement with the original speculation, this disulfide molecule has the highest vapor pressure and the lowest affinity towards the carbon surface. This is followed by the breakthrough of methyl ethyl disulfide. At this second breakthrough, the sulfur uptake of the sorbent was higher than 10% wt. S. This was followed by the diethyl disulfide breakthrough with total sulfur capacity in excess of 12.5% wt. S.

Operating the hybrid system in the presence of high concentration of mercaptans and at high pressures both resulted in a high partial pressure of the sulfur compounds. The use of high concentrations/partial pressures of the sulfur components, particularly methyl mercaptan, substantially impacts the sulfur uptake of the sorbent. The sulfur capacity of the sorbent has improved by about 5-6 times under these conditions.

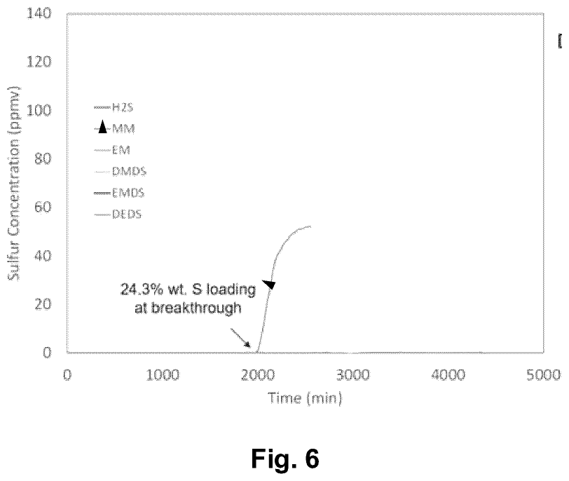

FIG. 6 shows mercaptan and disulfide breakthroughs in a bench-scale test where 75 ppmv methyl mercaptan and 75 ppmv ethyl mercaptan, along with 5 ppmv H₂S was fed into the system at 142 psia. The gas was dry; the moisture content of the gas was <200 ppmv H₂O. At this pressure and mercaptan concentration, the sulfur uptake capacity of the sorbent was measured as 24.3% wt. S, or 243 mg S/g sorbent, which is about 6 times higher than that observed at low pressure.

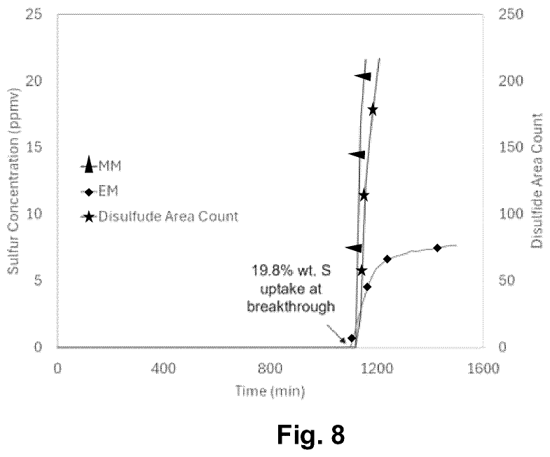

FIG. 8 shows the mercaptan and disulfide breakthroughs in a bench-scale experiment where 500 ppmv methyl mercaptan and 500 ppmv ethyl mercaptan was fed into the system at 17 psia. The gas was dry; the moisture content of the gas was <200 ppmv H₂O. At this pressure and mercaptan concentration, the sulfur uptake capacity of the sorbent was measured as 19.8% wt. S, or 198 mg S/g sorbent.

The significant increase in sulfur uptake capacity may be attributed to pore condensation. In addition to surface coverage of adsorption sites, the low molecular weight mercaptan molecules are condensed inside the pores. The pore size in the mesoscale range may enable the access of the large disulfide molecules into the pores and the large pore volume may allow the pores to hold onto a large amount of disulfide condensate.

Operation parameters can have a critical impact on the sorbent performance. A series of parametric tests, described below, outline an embodiment of operation conditions.

### Catalyst:Sorbent Ratio

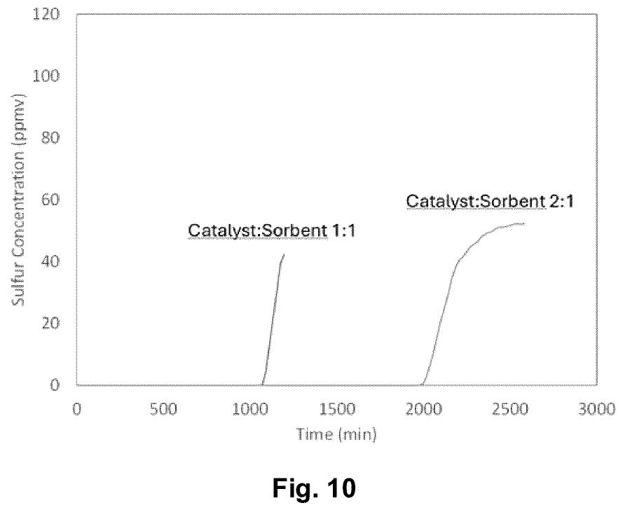

Two experiments were run with catalyst-to-sorbent ratio of 1:1 and 1:2. The experiments showed that the overall sulfur uptake was increased from 14% wt. S to 24% wt. S, when the catalyst-sorbent ratio was increased from 1:1 to 2:1. The reduction in the catalyst amount led to an early release of methyl mercaptan. FIG. 10 shows the breakthrough profiles for total sulfur, ethyl mercaptan, and total disulfide compounds over the catalyst sorbent hybrid for the catalyst-to-sorbent ratio tests. The total sulfur may include the mercaptan and the disulfide

### Temperature

An embodiment of the catalyst-sorbent hybrid system was evaluated at 30° C. and 50° C., which represents a common temperature range in gas processing applications. The sorbent achieved about 18% and about 24% wt. S uptake at 30° C. and 50° C. respectively. The temperature may impact the different components of the hybrid process, for example the catalyst and the sorbent, differently. Elevated temperature may benefit catalytic performance, while adversely impacting the sorbent performance. These result show that catalytic conversion of the mercaptans to disulfide may have higher importance in the overall conversion process.

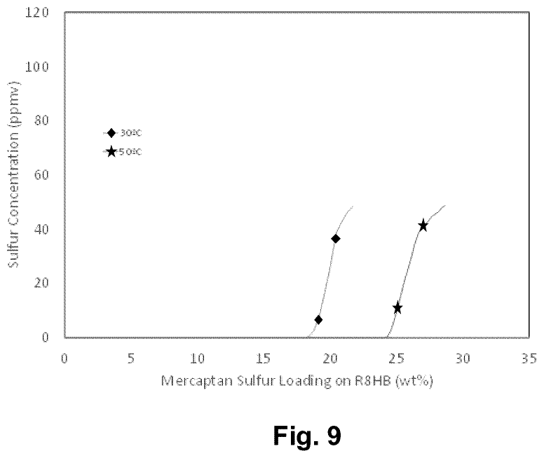

FIG. 9 shows breakthrough profiles for total sulfur, ethyl mercaptan, and total disulfide compounds over the catalyst sorbent hybrid for the temperature tests. Catalyst:Sorbent Volume Ratio: 2:1, T=30° C. and 50° C., 500 ppmv methyl mercaptan and 500 ppmv ethyl mercaptan, <200 ppmv H₂O in natural gas, P=17 psia, GHSV=1,800 h⁻¹.

### Moisture Content of the Gas

The catalyst may be grafted with surface hydroxyl groups which work as proton acceptors in the dimerization reaction, which may result in the formation of H₂O which may be eluted from the bed. As the number of (—OH) groups may be limited, catalytic activity may be reduced, as these groups react with protons and convert to water. The gas streams that contain moisture have the potential to replenish these groups and provide an extended catalytic life.

The experiments with the wet (1% v/v H₂O) and dry gas (<200 ppm) have shown that the catalyst will achieve 11.4% wt. S and 24.3% wt. S, respectively. These tests showed different breakthrough profiles. When the gas stream is dry, the catalyst runs out of the —OH groups, and mercaptan dimerization stops, resulting in methyl mercaptan being the first sulfur compound to breakthrough from the bed.

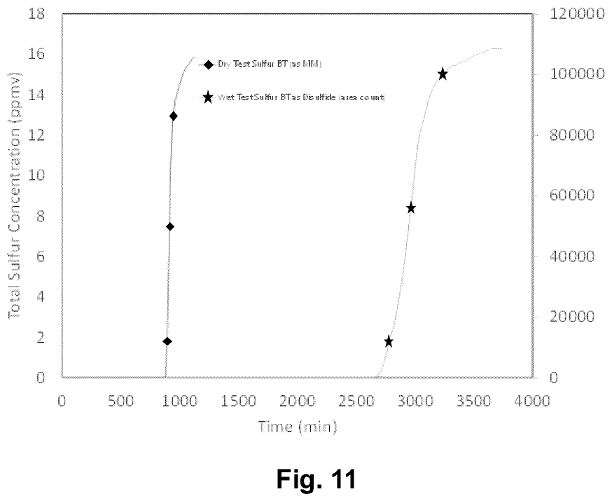

FIG. 11 shows breakthrough profiles for total sulfur, ethyl mercaptan, and total disulfide compounds over the catalyst sorbent hybrid system for the moisture content tests.

The new surface modified carbon sorbent may also be evaluated for COS and CS₂ removal. The new material may be utilized in both bench-scale and in full-scale field applications.

### Example: COS Removal Performance in Treating Natural Gas

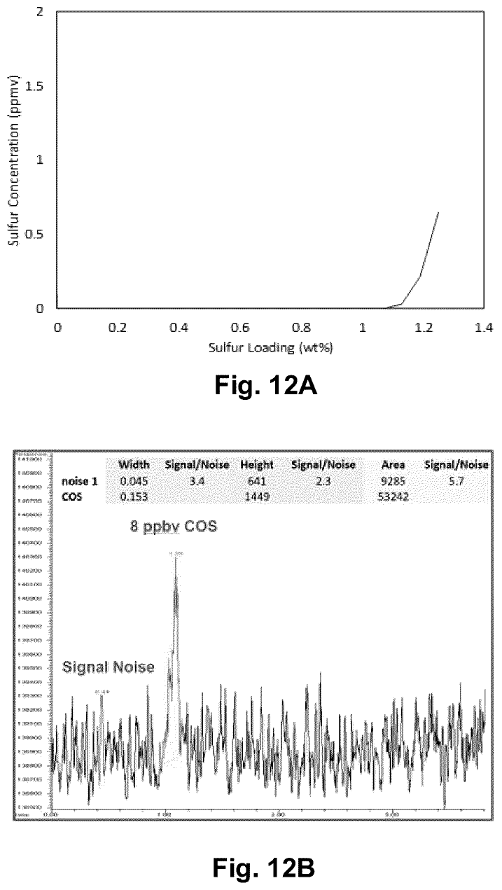

FIG. 12A shows a COS breakthrough profile over the sorbent and FIG. 12B shows a chromatogram generated using the GC/SCD analysis system indicating the sulfur detection sensitivity.

The natural gas stream contained over 3% v/v of hydrocarbons C₃ and higher and 2.2% v/v CO₂. The gas was dry; the total H₂O concentration was measured at 185 ppmv within the range indicated by U.S. pipeline specification. In this test, the gas is doped with additional amounts of cyclic compounds both with benzene, which is an aromatic, and cyclohexene, which is an aliphatic, in high concentrations to assess their impact on the sulfur removal capability of the sorbent.

The presence of heavy hydrocarbons, particularly aromatics, olefins and aliphatics, are generally a concern for carbon sorbents due to the high affinity of these species to adsorb onto the activated carbon surfaces, with potential to render the active groups responsible for sulfur adsorption inactive. Heavy hydrocarbons may include C₅ and higher. The 70 ppmv benzene and 70 ppmv cyclohexene were added to the gas mixture. This exceeds the 10 ppmv COS present in the gas, and the high concentrations were meant to accelerate the effects of any degradation due to competitive adsorption against the COS. The sorbent bed was maintained at ambient temperature (22° C.) and at a gas pressure of 4 bara.

The modified carbon sorbent achieved about 1.1% wt. S uptake at the breakthrough, meaning 1.1 kg S was removed per 100 kg sorbent or 11 mg S/g sorbent. As shown in the breakthrough profile the total sulfur concentration in the natural gas is reduced to single digit ppbv. FIG. 12B shows a chromatogram measuring sulfur concentration at 8 ppbv at a signal-to-noise ratio greater than 5. The absence of any detectable sulfur compounds prior to the sulfur breakthrough suggests that the new sorbent can effectively remove the COS from compressed natural gas and achieve a very high sulfur removal efficiency to provide a high-level protection for any catalytic process that converts the natural gas to other chemicals, such as H₂, and enable its use in fuel cells without electrochemical degradation.

### Example: COS Removal Performance in Treating LPG, Olefins, and Light Hydrocarbon Fractions

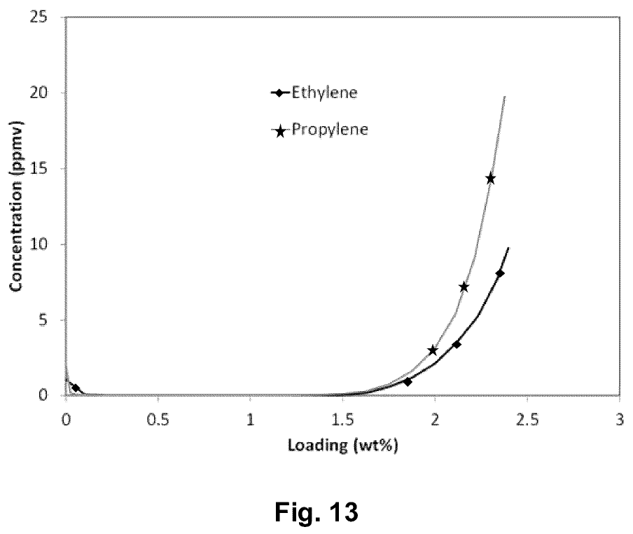

FIG. 13 shows breakthrough profiles of COS in neat 99+% ethylene and propylene streams. FIG. 13 shows the results of two separate tests in ethylene and pure propylene; the sulfur breakthrough results are provided in the same plot. The COS concentration in these tests was maintained at 40 ppmv. The temperature and pressure of the bed was maintained at 22° C. and 2 bara where both the ethylene and the propylene were in the gas phase. In both tests, the sulfur uptake over the material was greater 1.6% wt. S, or 16 mg S/g sorbent, at the breakthrough which indicates that the high selectivity towards the COS even in the presence of highly reactive olefins.

The material meets the process guarantees for testing sites treating different LPG, propane, i-butane, and n-butane feedstocks at commercial scale. These applications may require the treatment of the light hydrocarbon fraction in the liquid phase at ambient temperature (−10° C. to 50° C.) and at 200-250 psig pressure. In this embodiment, the starting COS concentration in the LPG was less than 1 ppmw S where the objective is to reduce it to less-than-detectable levels. The less-than-detectable levels may be <10 ppbw S. A small vessel contained only 220 gallons of sorbent to treat 40 gpm LPG flow, which gallons the COS concentration, along with other sulfur impurities in the LPG, to undetectable concentrations. The gas-liquid contact time in this process was 330 sec, with for example a Liquid Hourly Space Velocity of about 11 h⁻¹, which indicated a very high rate of removal of sulfur, in other words small beds may be used to treat large volumes of flow.

In a larger application, the sorbent performance has been demonstrated in a 15,000 lb bed treating 2.4 ppmw COS, as sulfur, at a flow rate of 11 agpm. One bed change-out was carried with no indication of problems in material integrity, including clumping or bridging, which makes the removal of the sorbent difficult, or pyrophoricty, meaning an increase of temperature upon exposing the spent material to air.

### Example: COS Removal Performance in Treating Biogas/Landfill Gas

In one embodiment for COS removal, the biogas may be treated before it enters the membrane separation system. Reducing the sulfur concentration at this location ensures the purity of both the permeate, which may contain CO₂, H₂O and most of the sulfur compounds, and retentate streams, which is the methane fraction. Upstream of the membrane the gas may be wet. Depending on the extent of compression and water knock out, the moisture content of the biogas can range from 1 to 6% v/v H₂O.

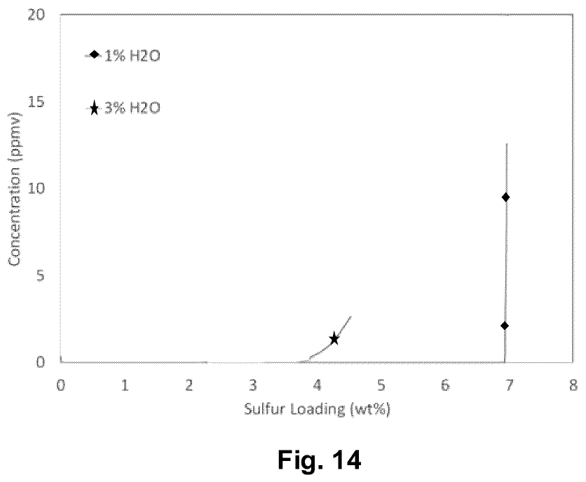

FIG. 14 shows the COS breakthrough profiles in two separate experiments where the H₂O content was varied from 1% to 3% H₂O v/v. In these tests, the bed temperature was maintained at 60° C. The COS concentration was maintained at 40 ppmv. In the test containing 1% v/v H₂O, the sulfur uptake was about 7% wt., meaning 70 mg S/g sorbent. The pre-breakthrough sulfur capacity was lower when the water concentration was increased to 3% H₂O v/v. The increase in the sulfur uptake in higher temperatures and water concentrations indicate that the COS removal reaction benefits from the higher temperature operation and the presence of moisture in the gas. When the temperature was increased to 80° C., the COS uptake increased to over 12% wt. S, or 120 mg S/g sorbent, a further justification of the beneficial effects of elevated bed temperature in the removal of COS over this material.

### Example: COS Removal Performance in Treating Pure CO₂ Fraction

The new carbon material has been evaluated in CO₂ purification applications, including qualifying the CO₂ product for food grade use. In this application, the sulfur sorbent may be applied prior to the cryogenic process that liquefies the CO₂ to make it ready for shipment using trucks.

The new modified carbon sorbent was loaded in a 2,000 L (70 CF) single column fixed bed reactor with 0.92 m (3 ft) in diameter and 3.1 m (10 ft) in height. The material removed all the sulfur compounds from the CO₂, including COS, enabling the company to make its first delivery of food grade liquefied CO₂ from their facility. The process conditions are as follows: gas composition 90% v/v CO₂ and 10% v/v CH₄; flow: 120 SCFM; temperature: 90° F.; pressure: 5 PSIG; sulfur concentration: 2.5 ppm; dew point: 37° F.

### Example: CS₂ Removal Performance from CO₂ Fractions

The sorbent performance for CS₂ removal from CO₂ has been evaluated in a series of experiments. A pure CO₂ stream with low concentrations of water less than 200 ppm was laden with 20 ppmv CS₂ and varying concentrations of methanol from 35 to 740 ppmv. In an embodiment, the CO₂ stream may be separated from synthesis gas using a methanol-containing solvent, such as Rectisol.

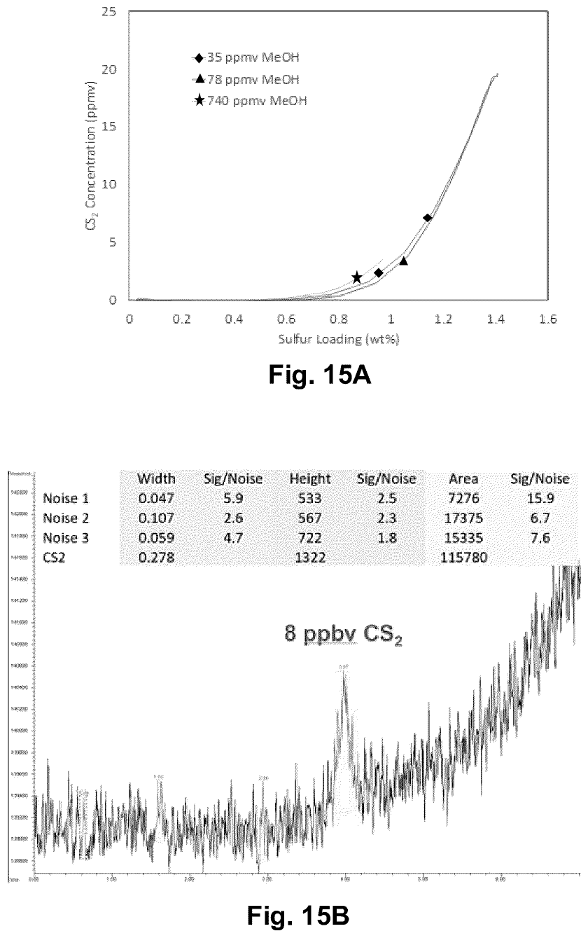

FIG. 15A shows a CS₂ breakthrough profile over the carbon sorbent in the presence of methanol. The modified carbon sorbent achieved about 0.8 wt. S uptake at the breakthrough, or 8 mg S/g sorbent. As shown in the breakthrough profile the total sulfur concentration in the natural gas is reduced to single digit parts per billion on volume basis.

FIG. 15B shows a chromatogram measuring sulfur concentration at 8 ppbv at a signal-to-noise ratio greater than 5. The absence of any detectable sulfur compounds prior to the sulfur breakthrough suggests that the new sorbent can effectively remove the CS₂ from compressed natural gas and achieve a very high sulfur removal efficiency to provide a high-level protection for any catalytic process that converts the natural gas to other chemicals, such as H₂, and enable its use in fuel cells without any potential electrochemical degradation.

### Example: CS₂ Removal Performance from CO₂ Fractions

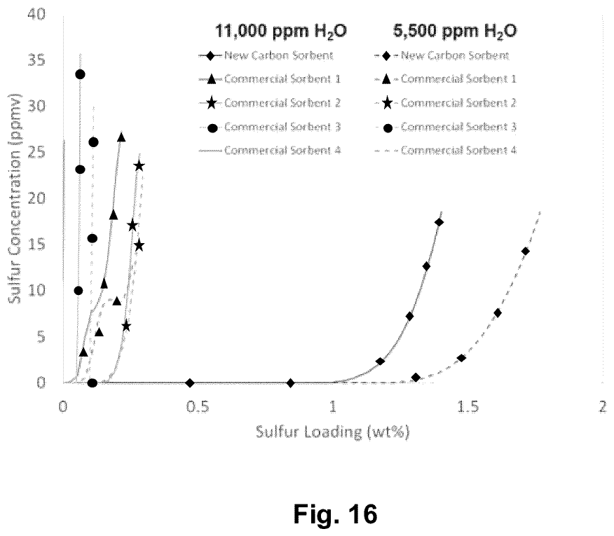

The CS₂ removal performance of the sorbent was also evaluated in “wet” biogas streams. FIG. 16 shows the comparison of the CS₂ removal breakthrough of the modified carbon sorbent against several commercial samples, including activated carbons, metal impregnated carbons, hydrophobic zeolites and metal-organic-framework based adsorbents, at 5,500 and 11,000 ppmv H₂O. These experiments showed that the disclosed carbon exhibits a significantly higher CS₂ uptake capacity under the dry and wet conditions.

The modified carbon sorbent achieved about 1.3% wt. S uptake at the breakthrough, or 13 mg S/g sorbent. Increasing the H₂O concentration from 5,500 to 11,000 ppmv only showed a small reduction in the sulfur uptake to about 1.1% wt. S, or 11 mg S/g sorbent, indicating stability against H₂O.

It is to be understood that not necessarily all objects or advantages may be achieved under any embodiment of the disclosure. Those skilled in the art will recognize that the system for organic sulfur removal, may be embodied or carried out in a manner that achieves or optimizes on advantage or group of advantages taught without achieving other object or advantages as taught or suggested.

The skilled artisan will recognize the interchangeability of various disclosed features. Beside the variations described, other known equivalents for each feature can be mixed and matched by one of ordinary skill in this art to make or use a system for organic sulfur removal. It will be understood by the skilled artisan that the features described may be adapted to other species or processes. Hence this disclosure and embodiments and variations thereof are not limited to natural gas, light hydrocarbons, biogas, and carbon dioxide, but rather can be utilized in any process wherein organic sulfur removal is desired or required.

Although this disclosure describes certain exemplary embodiments and examples of carbon dioxide, it therefore will be understood by those skilled in the art that the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

1. A process for removing a pollutant from a CO₂ rich stream, the process comprising:
Using a catalyst to dimerize the pollutant into a disulfide, and
Removing the disulfide via an adsorbent.

2. The process of claim 1, wherein the pollutant is mercaptans.

3. The process of claim 1, wherein the pollutant is COS.

4. The process of claim 1, wherein the pollutant is CS₂.

5. The process of claim 1, wherein the pollutant is a complex sulfide/disulfide compound.

6. The process of claim 1, wherein the CO₂ rich stream is natural gas.

7. The process of claim 1, wherein the CO₂ rich stream is natural gas liquids.

8. The process of claim 1, wherein the adsorbent is a multi-functional mesoporous activated carbon sorbent.

9. The process of claim 8, wherein the mesoporous activated carbon sorbent has a pore size of 10-30 Å.

10. The process of claim 1, wherein the catalyst is a mixed-metal oxide grafted with reactive hydroxyl groups.
